(19) United States
(12) Patent Application Publication
(10) Pub. No.: US 2020/0065892 A1
(43) Pub. Date: Feb. 27, 2020

(54) Computer Implemented Method for Ordering Customizable Dishes with Reverse Auction Bidding

(71) Applicant: Jermaine Brown, Troy, NY (US)

(72) Inventor: Jermaine Brown, Troy, NY (US)

(21) Appl. No.: 16/108,593

(22) Filed: Aug. 22, 2018

(51) Int. Cl. G06Q 30/08; G06Q 30/06; G06F 3/0482; G06Q 10/08; H04W 4/02

(52) U.S. Cl. CPC G06Q 30/08; G06Q 30/0621; H04W 4/02; G06F 3/0482; G06Q 10/0875; G06Q 30/0641

(57) ABSTRACT

A computer implemented method for ordering customizable dishes with reverse auction bidding is disclosed. A first software application is used by a consumer user to input order items, where order items are at least one customized order creatable from selected ingredients and optionally containing prepared food items. The first software application communicates the order to a database management system, which compares the order items to a list of menu items and ingredients available from producer users on a database. The database management system then sends the customizable items creatable from ingredients to the producer users, who bid on them in a reverse auction. The bids and the ordered menu items are then communicated to the consumer user for final approval.

### I. FIELD OF THE INVENTION

The present invention relates generally a computer implemented method for ordering customizable dishes using reverse auction bidding, and a method of using the same.

### II. BACKGROUND

In order to save money and limited ingredients, restaurants tend to limit what is available on their menus by what supplies they have on hand, resulting in a preset selection of options that are available for purchase by the consumer. Some restaurants may be persuaded to create custom orders from ingredients available on hand, but this is dependent on the consumer going to the restaurant and persuading the restaurant to create this custom item. With the advent of the Internet, it is possible to compare what one or more restaurants have on hand with a custom order that a consumer wishes to have provided, and quickly and effectively arrange for an exchange for a custom order. Therefore, there is a need for a computer implemented method for ordering customizable dishes using reverse auction bidding, and a method of using the same.

### III. SUMMARY OF THE INVENTION

A first aspect of the present invention provides a computer implemented method for ordering customizable dishes with reverse auction bidding. A first step of the method comprises providing a first software application on a first computer for use by a consumer user. A second step of the method is comprised of providing a second computer having a database management system software application and a first database, where the first database is managed by the database management system. The first database contains menu items and ingredients available from each of a plurality of producer users. The consumer user is in communication with the first software application. The first software application is in communication with the database management system. The database management system is in communication with the first software application and the plurality of producer users. A third step of the method is comprised of the first software application accepting input of order items from the consumer user, where order items are at least one customized order creatable from selected ingredients and optionally containing prepared food items. A fourth step of the method is comprised of the first software application communicating the order items with the database management system. A fifth step of the method is comprised of the database management system comparing the order items selected by the consumer user to the list of menu items and ingredients on the first database. A sixth step of the method is comprised of the database management system dividing the order items into menu items available from the producer user and customizable orders creatable from ingredients. A seventh step of the method is comprised of communicating the customizable orders creatable from ingredients to the producer users. An eighth step of the method is comprised of the producer users bidding in a reverse auction to provide the customizable orders creatable from ingredients to the consumer user. A ninth step of the method is comprised of communicating the bids of the producer users to the database management system. A tenth step of the method is comprised of the database management system sorting the bids of the producer users and communicating the cost of the menu items found in the database and the bids of the producer users to the first software application. An eleventh step of the method is comprised of the first software application communicating to the consumer user the sorted bids of the producer users. A twelfth step of the method is comprised of the consumer user selecting from the bids for final approval.

A second aspect of the present invention provides a computer implemented method for ordering customizable dishes with reverse auction bidding. The first step of the method is comprised of providing a first software application on a first computer for use by a consumer user. A second step of the method is comprised of providing a second computer having a database management system software application and a first database. The database management system is in communication with the first software application. A third step of the method is comprised of providing a second software application on one or more computers for use by one or more producer users, where the database management system is in communication with the second software application. A fourth step of the method is comprised of the second software application accepting input from the one or more producer users selected from the group consisting of available menu items, and available ingredients. A fifth step of the method is comprised of the second software application communicating the input with the database management system where the first database is managed by the database management system, where the first database contains menu items and ingredients available from each of a plurality of producer users and provided by the second software application, and where the consumer user is in communication with the first software application. The first software application is in communication with the database management system. The database management system is in communication with the first software application. A sixth step of the method is comprised of the first software application accepting input of order items from the consumer user, where order items are at least one customized order creatable from selected ingredients and optionally containing prepared food items. A seventh step of the method is comprised of the first software application communicating the order items with the database management system. An eighth step of the method is comprised of the database management system comparing the order items selected by the consumer user to the list of menu items and ingredients on the first database. A ninth step of the method is comprised of the database management system dividing the order items into menu items available from the producer user and customizable orders creatable from ingredients. A tenth step of the method is comprised of communicating the customizable orders creatable from ingredients to the second software application. An eleventh step of the method is comprised of the second software application communicating the customizable orders creatable from ingredients to the producer users. A twelfth step of the method is comprised of the second software application accepting input from the one or more producer users consisting of bidding in a reverse auction to provide the customizable orders creatable from ingredients to the consumer user. A thirteenth step of the method is comprised of the second software application communicating the bids of the producer users to the database management system. A fourteenth step of the method is comprised of the database management system sorting the bids of the producer users and communicating the cost of the menu items found in the database and the bids of the producer users to the first software application. A fifteenth step of the method is comprised of the first software application communicating to the consumer user the sorted bids of the producer users. A sixteenth step of the method is comprised of the first software application accepting input of final approval of the bids and menu items by the consumer user. A seventeenth step of the method is comprised of the first software application communicating the final approval to the database management system. An eighteenth step of the method is comprised of the database management system communicating the final approval to the second software application. A nineteenth step of the method is comprised of the second software application communicating the final approval to the producer users whose bids have been selected.

### BRIEF DESCRIPTION OF THE DRAWINGS

The features of the invention are set forth in the appended claims. The invention itself, however, will be best understood by reference to the following detailed description of an illustrative embodiment when read in conjunction with the accompanying drawings, wherein:

FIG. 1 depicts a block diagram of a computer implemented method for ordering customizable dishes using reverse auction bidding, in accordance with embodiments of the present invention; and

FIGS. 2A and 2B depict a flow diagram of a computer implemented method for ordering customizable dishes using reverse auction bidding, in accordance with embodiments of the present invention; and

FIG. 3 depicts a block diagram of a computer implemented method for ordering customizable dishes using reverse auction bidding, in accordance with embodiments of the present invention; and

FIGS. 4A and 4B depicts a flow diagram of a computer implemented method for ordering customizable dishes using reverse auction bidding, in accordance with embodiments of the present invention; and

FIG. 5 depicts a diagram of a computer implemented method for ordering customizable dishes using reverse auction bidding; and

FIG. 6 depicts a block diagram of a computer implemented method for ordering customizable dishes using reverse auction bidding, in accordance with embodiments of the present invention; and

FIG. 7 depicts a block diagram of a computer implemented method for ordering customizable dishes using reverse auction bidding, in accordance with embodiments of the present invention in accordance with embodiments of the present invention.

### DETAILED DESCRIPTION OF THE EMBODIMENTS OF THE INVENTION

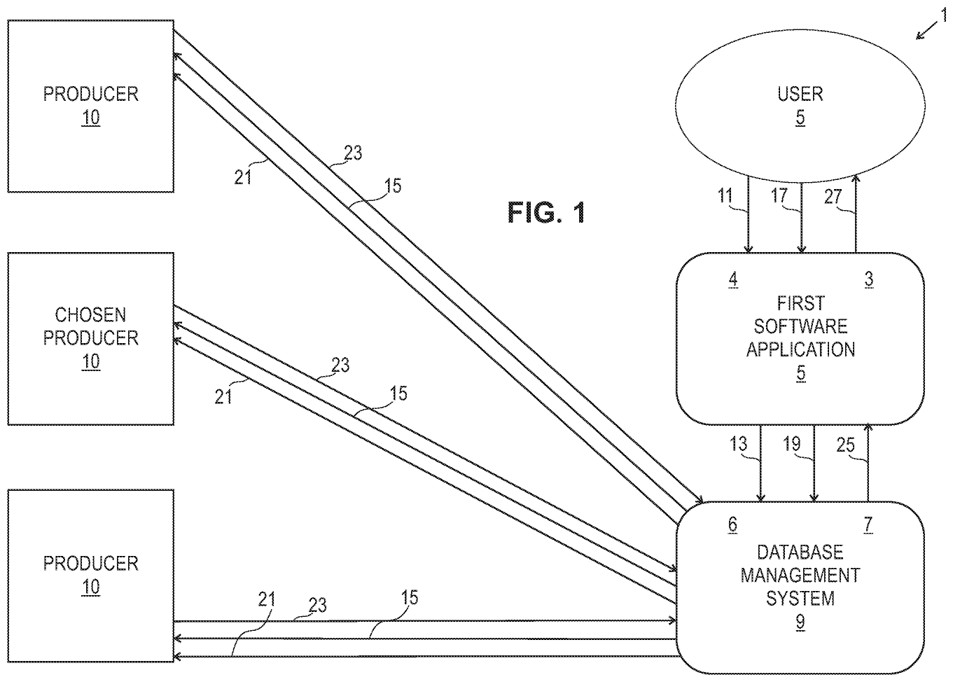

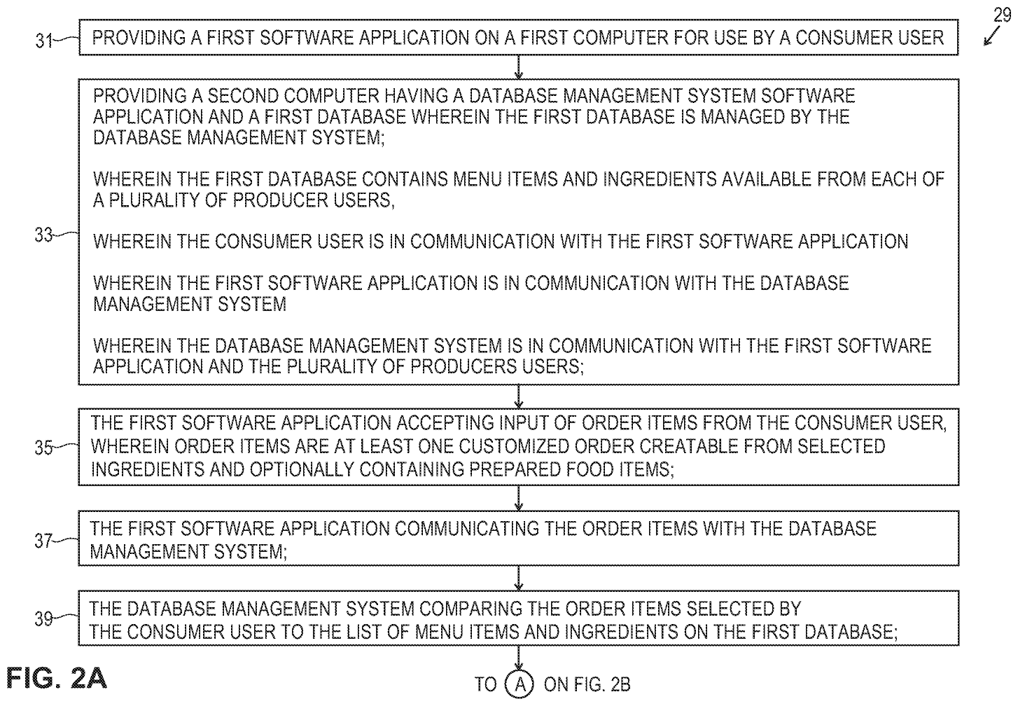

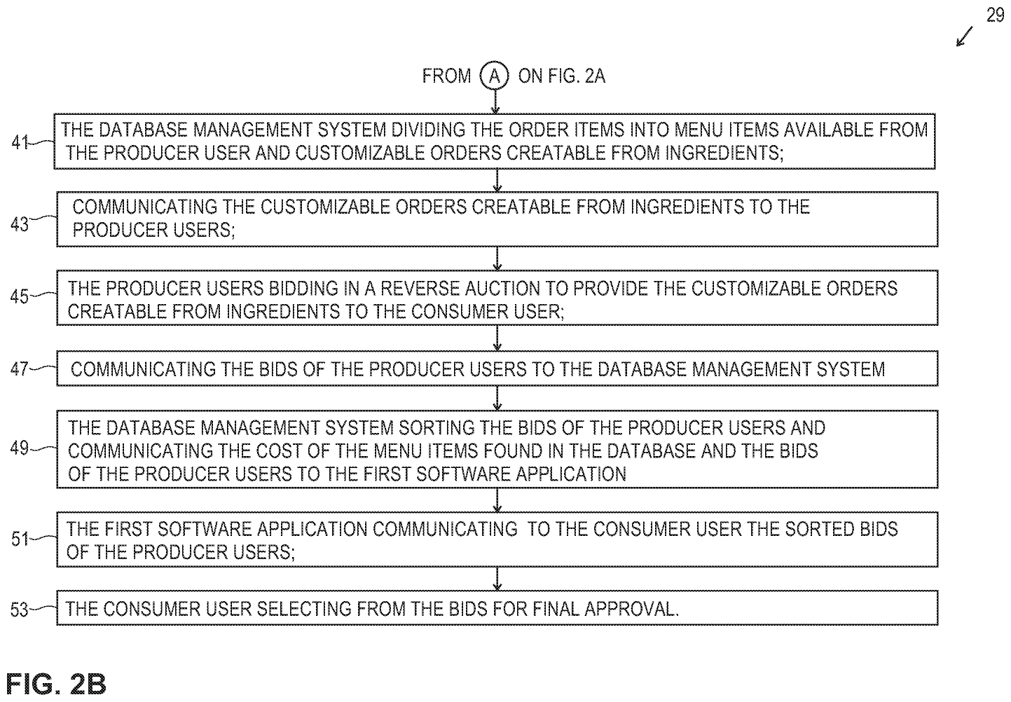

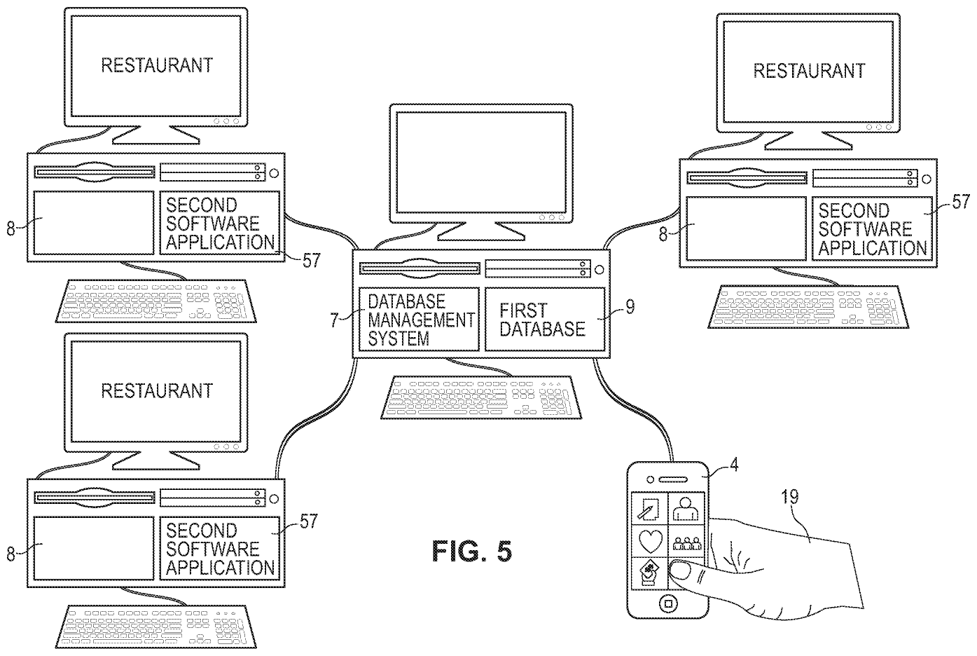

FIG. 1 depicts a block diagram of a first aspect of the present invention. FIGS. 2A and 2B depicts a flow diagram of the first aspect of the present invention. The first aspect of the present invention provides a computer implemented method 1 for ordering customizable dishes with reverse auction bidding. A first step 31 of the method 1 comprises providing a first software application 3 on a first computer 4 for use by a consumer user 5, as shown in FIG. 5. A second step 33 of the method 1 is comprised of providing a second computer 6 having a database management system software application 7 and a first database 9, where the first database 9 is managed by the database management system 7, as shown in FIG. 5. The first database 9 contains menu items and ingredients available from each of a plurality of producer users 10. The consumer user is in communication 11 with the first software application. The first software application 3 is in communication 13 with the database management system. The database management system is in communication 15 with the first software application and the plurality of producers users. A third step 35 of the method 1 is comprised of the first software application 3 accepting input 17 of order items from the consumer user, where order items are at least one customized order creatable from selected ingredients and optionally containing prepared food items. A fourth step 37 of the method 1 is comprised of the first software application 3 communicating 19 the order items with the database management system. A fifth step 39 of the method 1 is comprised of the database management system 7 comparing the order items selected by the consumer user to the list of menu items and ingredients on the first database 9. A sixth step 41 of the method 1 is comprised of the database management system 7 dividing the order items into menu items available from the producer user and customizable orders creatable from ingredients. A seventh step 43 of the method 1 is comprised of communicating 21 the customizable orders creatable from ingredients to the producer users 10. An eight step 45 of the method 1 is comprised of the producer users 10 bidding in a reverse auction to provide the customizable orders creatable from ingredients to the consumer user. A ninth step 47 of the method 1 is comprised of communicating 23 the bids of the producer users to the database management system. A tenth step 49 of the method 1 is comprised of the database management system 7 sorting the bids of the producer users 10 and communicating 25 the cost of the menu items found in the database and the bids of the producer users to the first software application. An eleventh step 51 of the method 1 is comprised of the first software application 3 communicating 27 to the consumer user the sorted bids of the producer users. A twelfth step 53 of the method 1 is comprised of the consumer user selecting from the bids for final approval.

In an embodiment, the first computer 4, second computer 6, or first and second computers are a computer, tablet, smartphone, or server.

In an embodiment the selection of producer users 10 are constrained by the consumer user's location.

In an embodiment, final approval includes an exchange of payment by the consumer user 5.

In an embodiment, the first software application 3 offers accumulated discounts for future orders. In an embodiment, payment is withheld until the order is confirmed by both producer and consumer users 5, 10. In an embodiment, the exchanges of payment are selected from a list consisting essentially of: a credit card, debit card, cash upon arrival, third party payment system, or cryptocurrency. In an embodiment, payment includes a service charge for the consumer user of the application.

In an embodiment, the producer users 10 are charged a service charge for use of the application. In an embodiment, the service charge is selected from the group consisting of: A flat fee, a percentage of the final order, or both a flat fee and a percentage of the final offer.

In an embodiment, final approval further comprises the consumer user 5 selecting to pick up the ordered items or arrange for delivery. In an embodiment, one or more drivers delivers the ordered items. The one or more drivers communicate their one or more locations and estimated time of arrival with the database management system. The database management system communicates the one or more drivers one or more locations and one or more estimated times of arrival with the first user. In an embodiment, the location of the consumer user is communicated to the main database, and wherein the main database communicates the location of the consumer user to the one or more drivers.

In an embodiment, orders creatable from ingredients that do not match any lists of ingredients provided by producer users, and orders creatable from ingredients that are not bid upon by consumer users, are communicated to the consumer user as unavailable items.

In an embodiment, a record of unavailable items ordered by consumer users are recorded and provided to producer users upon request.

In an embodiment, the producer users are charged a fee for access to the recorded record.

In an embodiment, the order items are selected from a menu user interface created from the list of menu items provided by the producer users, and a customizable input of orders creatable from ingredients.

In an embodiment, the menu user interface additionally provides orders creatable from ingredients that have been previously fulfilled by producer users.

In an embodiment, the menu user interface ranks inputs by popularity ratings by consumer users.

In an embodiment, a rating system is provided to rate menu items or custom orders creatable from ingredients after the consumer user has given final approval.

In an embodiment, the consumer user may select a preferred radius of constraint to constrain the set of producers by location relative to the user's immediate are.

In an embodiment, the application allows for multiple ordered items to be ordered for providing at multiple times. The application 3 then may offer a discount for ordering multiple order items to be provided at multiple times.

In an embodiment, the database management system generates a recommended price for reverse auction bids on orders creatable from ingredients, based on previous data of similar items, and communicates the recommended price to the producer users.

In an embodiment, the application is optimized for use on mobile devices.

In an embodiment, the application is optimized for use on personal computers.

In an embodiment, the application is optimized for use on tablets.

In an embodiment, the consumer user is not in direct communication with the database management system and can only limitedly access database management systems through the first software application, wherein the producer users are not in direct communication with the consumer user and can only indirectly communicate with the consumer user through the database management system.

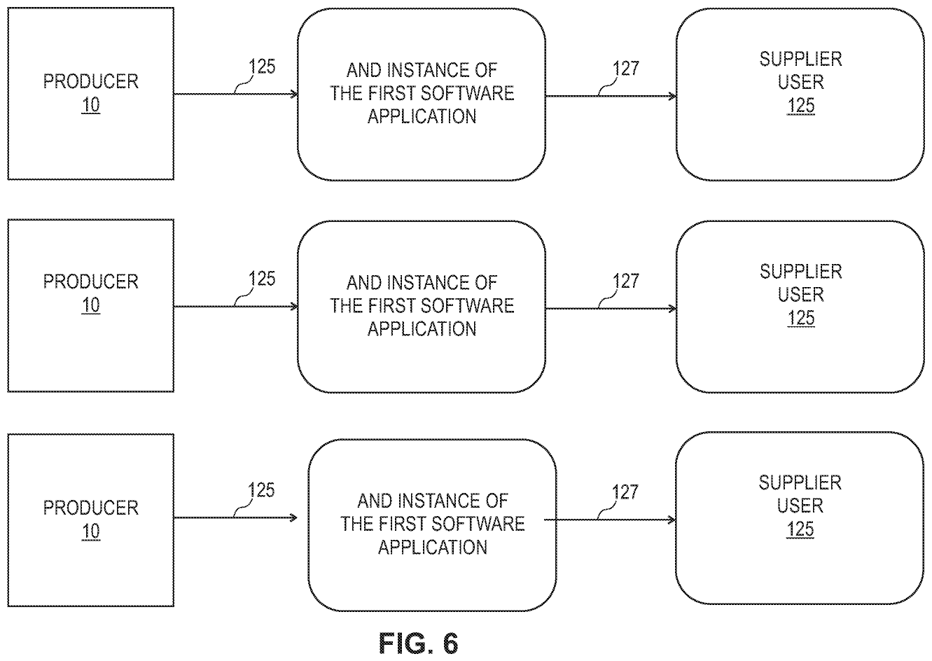

In an embodiment, the first software application 3 is provided on a plurality of computers, as shown in FIG. 6. The producer user(s) 17 is in communication 125 with the first software application 3. The producer user(s) 17 provides menu items and ingredients available from each of a plurality of producer users.

In an embodiment, consumer users' 19 use of the first software application automatically generate a publicly viewable user profile with their general location and top rated customized orders.

In an embodiment, the producer users communicate 125 total ingredients available to the first database system, and communicate at least one supplier user 125 to the first database system and what ingredients the at least one supplier user 125 supplies. The database management system 9 tracks ingredients 15 used in menu items and customized orders from each individual producer such that it keeps a running tally of that available ingredients each producer user has on hand. The first database system 9 contacts 127 the supplier user of an ingredient when producer users' available ingredients fall below a specified threshold. Supplier users 125 then provide the needed ingredients to the producer users.

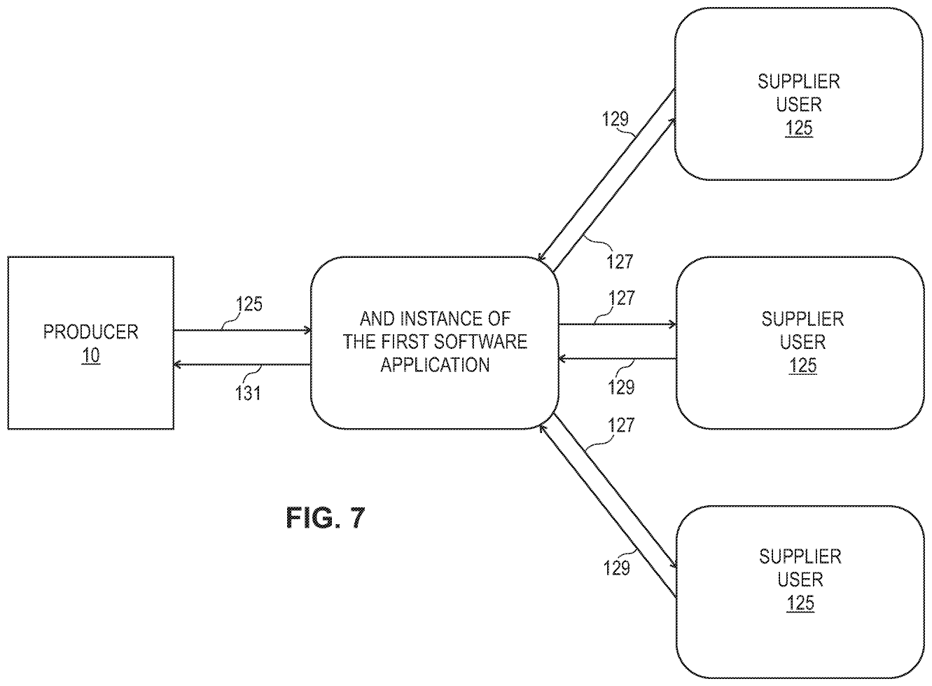

In an embodiment, supplier users 125 bid in a reverse auction to provide the ingredients to the producer user, as shown in FIG. 7. The bids of the supplier users are communicated 129 to the database management system, the database management system sorting the bids of the supplier users 125 and communicating 131 the bids of the supplier users to the first software application 3. The first software application then communicates to the producer user the sorted bids of the supplier users and the producer user selects from the bids for final approval.

In an embodiment, final approval includes an exchange of payment by the producer user.

In an embodiment, the application offers accumulated discounts for future orders.

In an embodiment, payment is withheld until the order is confirmed by both producer and consumer users.

In an embodiment, the exchanges of payment are selected from a list consisting essentially of: credit card, debit card, cash upon arrival, third party payment system, or cryptocurrency.

In an embodiment, payment includes a service charge for the producer user of the application.

In an embodiment, payment includes a service charge for the supplier user of the application.

In an embodiment, the service charge is selected from the group consisting of: A flat fee, a percentage of the final order, or both a flat fee and a percentage of the final offer.

In an embodiment, final approval further comprises the producer user selecting to pick up the ordered items or arrange for delivery.

In an embodiment, one or more drivers delivers the ordered items. The drivers communicate their one or more locations and estimated time of arrival with the database management system, and the database management system communicates the one or more drivers one or more locations and one or more estimated times of arrival with the producer user.

In an embodiment, the location of the producer user is communicated to the main database, and wherein the main database communicates the location of the consumer user to the one or more drivers.

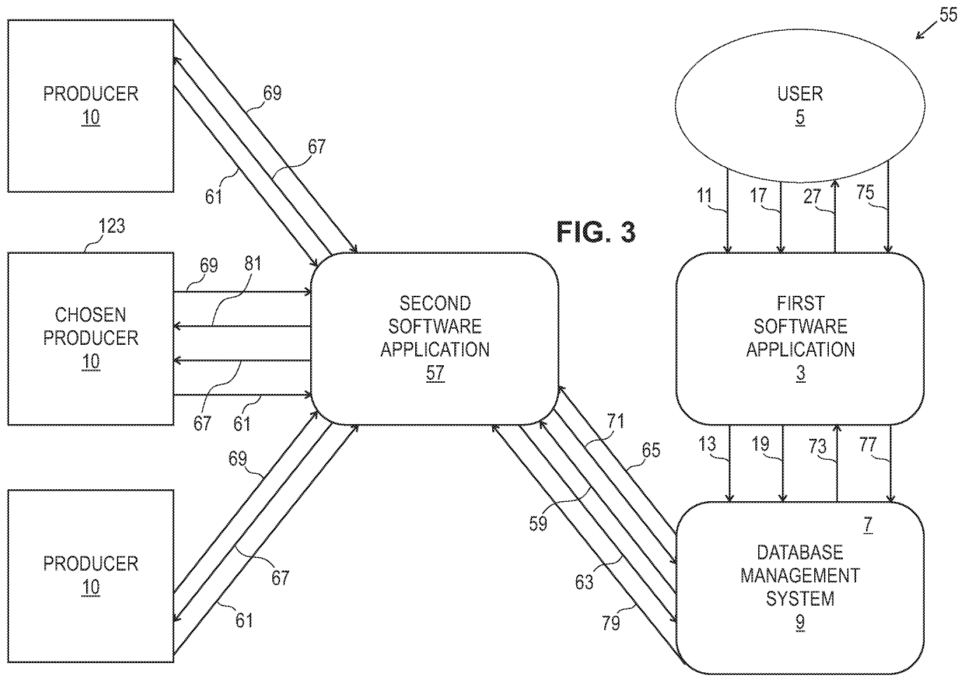

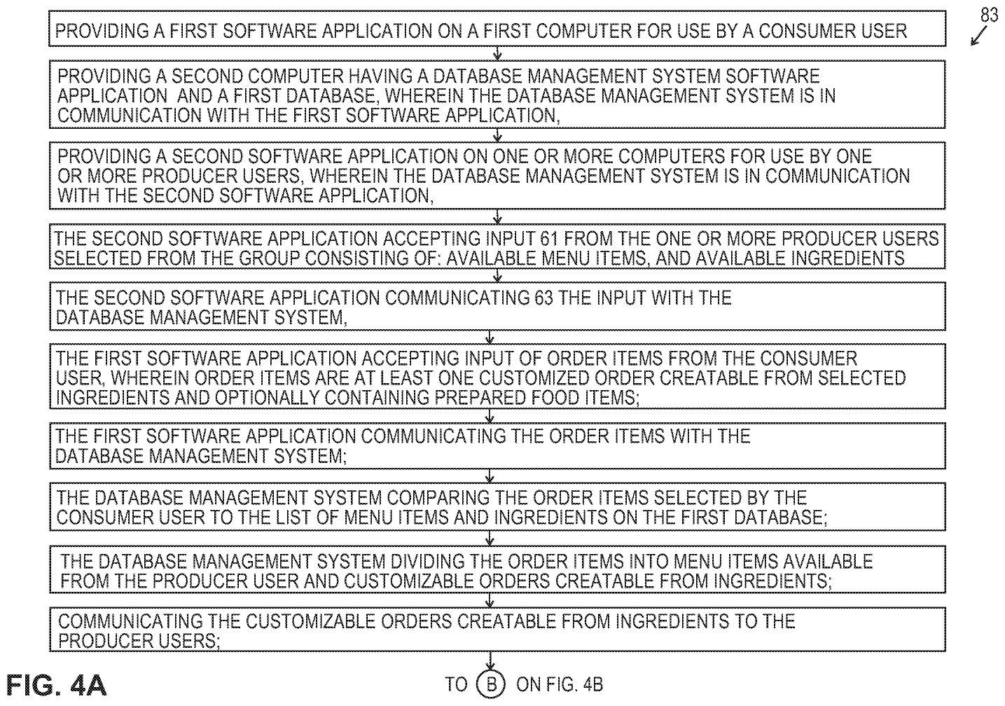

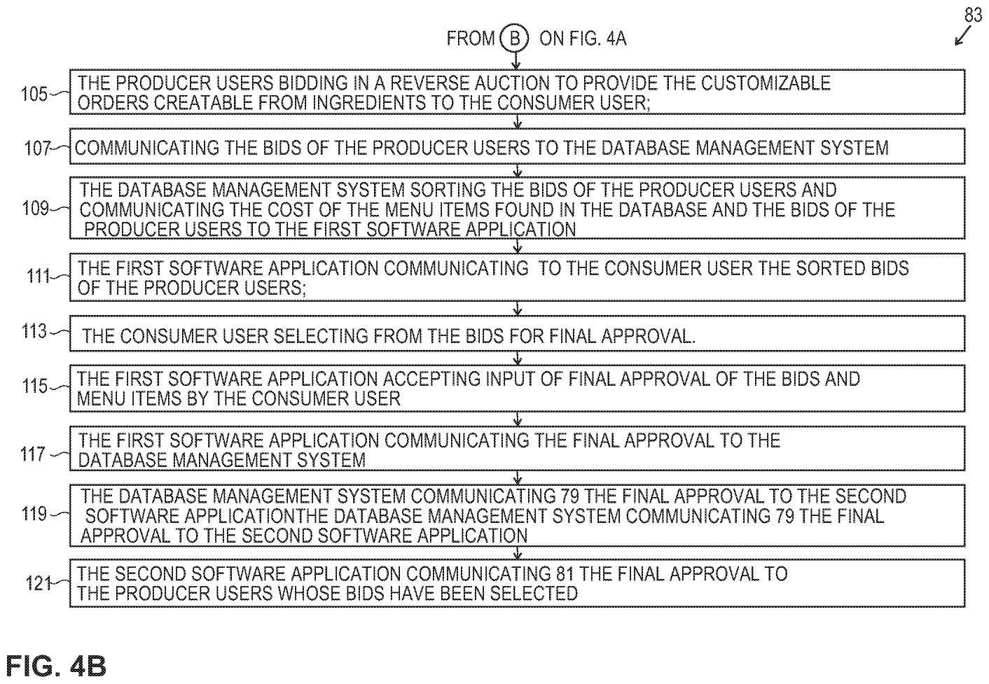

FIG. 3 depicts a block diagram of a second aspect of the present invention, in accordance with embodiments of the present invention. FIGS. 4A and 4B depicts a flow diagram of the second aspect of the present invention, in accordance with embodiments of the present invention. The second aspect of the present invention provides a computer implemented method 55 for ordering customizable dishes with reverse auction bidding. The first step 85 of the method 55 is comprised of providing a first software application 3 on a first computer for use by a consumer user. A second step 87 of the method 55 is comprised of providing a second computer 6 having a database management system software application 7 and a first database 9, as shown in FIG. 5. The database management system is in communication 11 with the first software application 3. A third step 89 of the method 55 is comprised of providing a second software application 57 on one or more computers 8 for use by one or more producer users, where the database management system is in communication 59 with the second software application. A fourth step 91 of the method 55 is comprised of the second software application 57 accepting input 61 from the one or more producer users selected from the group consisting of available menu items, and available ingredients. A fifth step 93 of the method 55 is comprised of the second software application 57 communicating 63 the input with the database management system where the first database 9 is managed by the database management system 7, where the first database 9 contains menu items and ingredients available from each of a plurality of producer users 10 and provided 61 by the second software application 57, and where the consumer user 5 is in communication 11 with the first software application. The first software application 3 is in communication 13 with the database management system. The database management system is in communication 15 with the first software application 3. A sixth step 95 of the method 55 is comprised of the first software application 3 accepting input of order items 17 from the consumer user 5, where order items are at least one customized order creatable from selected ingredients and optionally containing prepared food items. A seventh step 97 of the method 55 is comprised of the first software application communicating 19 the order items with the database management system 7. An eighth step 99 of the method 55 is comprised of the database management system 7 comparing the order items selected by the consumer user to the list of menu items and ingredients on the first database 9. A ninth step 101 of the method 55 is comprised of the database management system 7 dividing the order items into menu items available from the producer user and customizable orders creatable from ingredients. A tenth step 103 of the method 55 is comprised of communicating 65 the customizable orders creatable from ingredients to the second software application 57. An eleventh step 105 of the method 55 is comprised of the second software application 57 communicating 67 the customizable orders creatable from ingredients to the producer users 10. A twelfth step 107 of the method 55 is comprised of the second software application 57 accepting input 69 from the one or more producer users consisting of bidding in a reverse auction to provide the customizable orders creatable from ingredients to the consumer user. A thirteenth step 109 of the method 55 is comprised of the second software application 57 communicating 71 the bids of the producer users to the database management system. A fourteenth step 111 of the method 55 is comprised of the database management system 7 sorting the bids of the producer users 10 and communicating 73 the cost of the menu items found in the database and the bids of the producer users 10 to the first software application. A fifteenth step 113 of the method 55 is comprised of the first software application 3 communicating 27 to the consumer user the sorted bids of the producer users. A sixteenth step 115 of the method 55 is comprised of the first software application 3 accepting input 75 of final approval of the bids and menu items by the consumer user 5. A seventeenth step 117 of the method 55 is comprised of the first software application 3 communicating 77 the final approval to the database management system 7. An eighteenth step 119 of the method 55 is comprised of the database management system 7 communicating 79 the final approval to the second software application 57. A nineteenth step 121 of the method 55 is comprised of the second software application 57 communicating 81 the final approval to the producer users whose bids have been selected 123.

FIG. 5 depicts a diagram of a computer implemented method for ordering customizable dishes using reverse auction bidding, in accordance with embodiments of the present invention. This shows the communications between the first software application 3 on a first computer for use by a consumer user, the second computer 6 having the database management system software application 7 and the first database 9, and the second software application 57 on one or more computers 8 for use by one or more producer users.

In an embodiment, the first computer 4, second computer 6, or first and second computers are a computer, tablet, smartphone, or server.

In an embodiment, the selection of producer users 10 are constrained by the consumer user's location.

In an embodiment, final approval includes an exchange of payment by the consumer user.

In an embodiment, the application offers accumulated discounts for future orders.

In an embodiment, payment is withheld until the order is confirmed by both producer and consumer users.

In an embodiment, the exchanges of payment are selected from a list consisting essentially of: credit card, debit card, cash upon arrival, third party payment system, or cryptocurrency.

In an embodiment, payment includes a service charge for the consumer user of the first application.

In an embodiment, the second software application provides information upon request from the group consisting of: a record of previously ordered menu items, a record of previously ordered customized orders, a record of unavailable items previously ordered by consumer users, and a recommendation of items that consumer users have ordered in other geographic locations might order in the future in proximity to the consumer users.

In an embodiment, the producer users 10 are charged a service charge for use of the second application.

In an embodiment, the service charge is selected from the group consisting of: A flat fee, a percentage of the final order, or both a flat fee and a percentage of the final offer.

In an embodiment, final approval further comprises the consumer user selecting to pick up the ordered items or arrange for delivery.

In an embodiment, one or more drivers delivers the ordered items. The one or more drivers then communicate their one or more locations and estimated time of arrival with the second software application 57. The second software application then communicates the one or more locations and estimated time of arrival with the database management system 7, which communicates the one or more drivers one or more locations and one or more estimated times of arrival with the first software application 3, which then communicates the one or more locations and estimated time of arrival with the consumer user 5.

In an embodiment, the location of the consumer user is communicated to the first application 3, which then communicates the location of the consumer user 5 to the main database 9, which then communicates the location of the consumer user 5 to the second software application 57. The second software application 57 then communicates the location of the consumer user 5 to the one or more drivers.

In an embodiment, orders creatable from ingredients that do not match any lists of ingredients provided by producer users, and orders creatable from ingredients that are not bid upon by consumer users, are communicated to the consumer user as unavailable items.

In an embodiment, the order items are selected from a menu user interface created from the list of menu items provided by the producer users, and a customizable input of orders creatable from ingredients.

In an embodiment, the menu user interface additionally provides orders creatable from ingredients that have been previously fulfilled by producer users.

In an embodiment, the menu user interface ranks inputs by popularity ratings by consumer users.

In an embodiment, a rating system is provided to rate menu items or custom orders creatable from ingredients after the consumer user has given final approval.

In an embodiment, the consumer user may select a preferred radius of constraint to constrain the set of producers by location relative to the user's immediate are.

In an embodiment, the application allows for multiple ordered items to be ordered for providing at multiple times, and the application offers a discount for ordering multiple order items to be provided at multiple times.

In an embodiment, the database management system generates a recommended price for reverse auction bids on orders creatable from ingredients, based on previous data of similar items, and communicates the recommended price to the second application, and the second application communicates the recommended price to the producer users.

In an embodiment, the first and second applications are optimized for use on mobile devices.

In an embodiment, the first and second applications 3, 57 are optimized for use on personal computers.

In an embodiment, the first and second applications 3, 57 are optimized for use on tablets.

In an embodiment, the consumer user is not in direct communication with the database management system and can only limitedly access database management systems through the first software application, wherein the producer users are not in direct communication with the consumer user and can only indirectly communicate with the consumer user through the second software application.

I claim:

1. A computer implemented method for ordering customizable dishes with reverse auction bidding, comprising:
providing a first software application on a first computer for use by a consumer user,
providing a second computer having a database management system software application and a first database,
wherein the first database is managed by the database management system;
wherein the first database contains menu items and ingredients available from each of a plurality of producer users,
wherein the consumer user is in communication with the first software application
wherein the first software application is in communication with the database management system
wherein the database management system is in communication with the first software application and the plurality of producers users;
the first software application accepting input of order items from the consumer user,
wherein order items are at least one customized order creatable from selected ingredients and optionally containing prepared food items;
the first software application communicating the order items with the database management system;
the database management system comparing the order items selected by the consumer user to the list of menu items and ingredients on the first database;
the database management system dividing the order items into menu items available from the producer user and customizable orders creatable from ingredients;
communicating the customizable orders creatable from ingredients to the producer users;
the producer users bidding in a reverse auction to provide the customizable orders creatable from ingredients to the consumer user;
communicating the bids of the producer users to the database management system;
the database management system sorting the bids of the producer users and communicating the cost of the menu items found in the database and the bids of the producer users to the first software application;
the first software application communicating to the consumer user the sorted bids of the producer users; and
the consumer user selecting from the bids for final approval.

2. The method of claim 1, wherein the first computer, second computer, or first and second computers are selected from the group consisting of a personal computer (PC), a tablet, a smartphone, and a server.

3. The method of claim 2, wherein the application is optimized for use on the first computer and the first computer is selected from the group consisting of a mobile device, a personal computer, and a tablet.

4. The method of claim 1, wherein the selection of producer users are constrained by the consumer user's location.

5. The method of claim 4, wherein the consumer user may select a preferred radius of constraint to constrain the set of producers by location relative to the user's immediate area.

6. The method of claim 1, wherein the producer users are charged a service charge for use of the application.

7. The method of claim 1, wherein orders creatable from ingredients that do not match any lists of ingredients provided by producer users, and orders creatable from ingredients that are not bid upon by consumer users, are communicated to the consumer user as unavailable items.

8. The method of claim 7, wherein a record of unavailable items ordered by consumer users are recorded and provided to producer users upon request.

9. The method of claim 8, wherein the producer users are charged a fee for access to the recorded record of unavailable items.

10. The method of claim 1, wherein the producer users communicate total ingredients available to the first database system,
wherein producers users communicate at least one supplier user to the first database system and what ingredients the at least one supplier user supplies,
wherein the first database system tracks ingredients used in menu items and customized orders from each individual producer such that it keeps a running tally of that available ingredients each producer user has on hand,
wherein the first database system contacts the supplier user of an ingredient when producer users' available ingredients fall below a specified threshold, and wherein supplier users provide the needed ingredients to the producer users.

11. The method of claim 10, wherein supplier users' bid in a reverse auction to provide the ingredients to the producer user, comprising:
communicating the bids of the supplier users to the database management system;
the database management system sorting the bids of the supplier users and communicating the bids of the supplier users to the first software application;
the first software application communicating to the producer user the sorted bids of the supplier users; and
the producer user selecting from the bids for final approval.

12. A computer implemented method for ordering customizable dishes with reverse auction bidding, comprising:
providing a first software application on a first computer for use by a consumer user,
providing a second computer having a database management system software application and a first database,
wherein the database management system is in communication with the first software application,
providing a second software application on one or more computers for use by one or more producer users,
wherein the database management system is in communication with the second software application,
the second software application accepting input from the one or more producer users selected from the group consisting of: available menu items, and available ingredients,
the second software application communicating the input with the database management system,
wherein the first database is managed by the database management system;
wherein the first database contains menu items and ingredients available from each of a plurality of producer users and provided by the second software application,
wherein the consumer user is in communication with the first software application,
wherein the first software application is in communication with the database management system,
wherein the database management system is in communication with the first software application;
the first software application accepting input of order items from the consumer user,
wherein order items are at least one customized order creatable from selected ingredients and optionally containing prepared food items;
the first software application communicating the order items with the database management system;
the database management system comparing the order items selected by the consumer user to the list of menu items and ingredients on the first database;
the database management system dividing the order items into menu items available from the producer user and customizable orders creatable from ingredients;
communicating the customizable orders creatable from ingredients to the second application;
the second software application accepting input from the one or more producer users consisting of bidding in a reverse auction to provide the customizable orders creatable from ingredients to the consumer user;
the second software application communicating the bids of the producer users to the database management system;
the database management system sorting the bids of the producer users and communicating the cost of the menu items found in the database and the bids of the producer users to the first software application;
the first software application communicating to the consumer user the sorted bids of the producer users;
the first software application accepting input of final approval of the bids and menu items by the consumer user;
the first software application communicating the final approval of the bids to the database management system;
the database management system communicating the final approval of the bids to the second software application; and
the second software application communicating the final approval of the bids to the producer users whose bids have been selected.

13. The method of claim 12, wherein final approval of the bids further comprises the consumer user selecting to pick up the ordered items or arrange for delivery.

14. The method of claim 13, wherein at least one driver(s) delivers the ordered items,
wherein the one or more drivers communicate their one or more locations and estimated time of arrival with the second software application,
wherein the second software application communicates the one or more locations and estimated time of arrival with the database management system,
wherein the database management system communicates the one or more drivers one or more locations and one or more estimated times of arrival with the first software application, and
wherein the first software application communicates the one or more locations and estimated time of arrival with the consumer user.

15. The method of claim 14, wherein the location of the consumer user is communicated to the first application,
wherein the first application communicates the location of the consumer user to the main database,
wherein the main database communicates the location of the consumer user to the second software application, and
wherein the second software application communicates the location of the consumer user to the one or more drivers.

16. The method of claim 12, wherein orders creatable from ingredients that do not match any lists of ingredients provided by producer users, and orders creatable from ingredients that are not bid upon by consumer users, are communicated to the consumer user as unavailable items.

17. The method of claim 12, wherein the order items are selected from a menu user interface created from the list of menu items provided by the producer users, and a customizable input of orders creatable from ingredients.

18. The method of claim 17, wherein the menu user interface additionally provides orders creatable from ingredients that have been previously fulfilled by producer users.

19. The method of claim 12,
wherein the selection of producer users are constrained by the consumer user's location, and
wherein the consumer user may select a preferred radius of constraint to constrain the set of producers by location relative to the user's immediate are.

20. The method of claim 12, wherein the first and second applications are optimized for use on a member of a group consisting of mobile devices, personal computers and tablets.
